(19) United States
(12) Patent Application Publication
(10) Pub. No.: US 2019/0034069 A1
(43) Pub. Date: Jan. 31, 2019

(54) Programmable Multi-touch On-screen Keyboard

(71) Applicant: Microsoft Technology Licensing, LLC, Redmond, WA (US)

(72) Inventor: Lakshmi Narayana MUMMIDI, Bellevue, WA (US)

(73) Assignee: Microsoft Technology Licensing, LLC, Redmond, WA (US)

(21) Appl. No.: 15/660,655

(22) Filed: Jul. 26, 2017

(51) Int. Cl. G06F 3/0488

(52) U.S. Cl. CPC G06F 3/04883; G06F 2203/04808

(57) ABSTRACT

An on-screen keyboard is provided by an operating system and user inputs are received by the user touching the on-screen keyboard. The on-screen keyboard supports multi-touch inputs, such as a gesture on the on-screen keyboard, or multiple objects concurrently touching the on-screen keyboard but remaining approximately stationary. The operating system exposes an interface to applications running on the computing device, allowing an application to specify what functionality different multi-touch inputs map to. The operating system then performs the mapped-to functionality whenever the operating system detects the corresponding multi-touch input. Additionally or alternatively, the operating system notifies the application of a detected multi-touch input to the on-screen keyboard and the application determines what functionality to perform in response to the multi-touch input. The operating system can pass all detected multi-touch inputs to the application or only a subset of detected multi-touch inputs to the application.

### BACKGROUND

As computing devices with touchscreens have become increasingly commonplace, the ability to enter data and commands to these computing devices via an on-screen keyboard has also become increasingly desired. However, given the small size of many of these touchscreens, using an on-screen keyboard can be difficult for users. On-screen keyboards may not provide keys for all inputs that a traditional full-size hardware keyboard provides, making it difficult for users to enter some data and commands, which can lead to user frustration with their devices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, an indication to map a first multi-touch input to first functionality is received from an application running on a computing device, and a record of a mapping of the first multi-touch input to the first functionality is maintained. Touch information describing user input to an on-screen keyboard of the computing device is received and a determination is made as to whether the touch information describes the first multi-touch input. In response to determining that the touch information describes the first multi-touch input, the first functionality is performed.

In accordance with one or more aspects, a description of a first multi-touch input to an on-screen keyboard of an operating system is provided to the operating system. An indication that a user input to the on-screen keyboard is the first multi-touch input is subsequently received from the operating system. In response to receiving the indication that the user input to the on-screen keyboard is the first multi-touch input, the first functionality is performed.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is a block diagram illustrating an example computing device implementing the programmable multi-touch on-screen keyboard in accordance with one or more embodiments.

FIG. 2 illustrates an example on-screen keyboard in accordance with one or more embodiments.

FIGS. 3, 4, 5, and 6 illustrate examples of multi-touch inputs in accordance with one or more embodiments.

FIG. 7 is a flowchart illustrating an example process for implementing a programmable multi-touch on-screen keyboard in accordance with one or more embodiments.

FIG. 8 is a flowchart illustrating another example process for implementing a programmable multi-touch on-screen keyboard in accordance with one or more embodiments.

FIG. 9 illustrates an example system that includes an example computing device that is representative of one or more systems and/or devices that may implement the various techniques described herein.

### DETAILED DESCRIPTION

A programmable multi-touch on-screen keyboard is discussed herein. The on-screen keyboard, also referred to as a soft keyboard, is a keyboard that is displayed on a touchscreen of a computing device. User inputs are received by the user touching the on-screen keyboard with an object, such as a stylus or finger. The on-screen keyboard is provided by an operating system of the computing device, and supports multi-touch inputs. These multi-touch inputs can include a user input that is a gesture on the on-screen keyboard. Such a gesture can be the result of a single object touching the on-screen keyboard (e.g., a single-finger gesture) or the result of multiple objects concurrently touching the on-screen keyboard (e.g., a two-finger or three-finger gesture). These multi-touch inputs can also include a user input that is multiple objects concurrently touching the on-screen keyboard but remaining approximately stationary (e.g., two or three fingers each touching a different key of the on-screen keyboard).

The operating system of the computing device displays the on-screen keyboard and identifies user inputs to the on-screen keyboard. The operating system can identify various different multi-touch inputs to the on-screen keyboard, such as different gestures, different key combinations, and so forth. The operating system exposes an interface to applications running on the computing device, allowing an application to specify what functionality different multi-touch inputs map to. The operating system then performs the mapped-to functionality whenever the operating system detects the corresponding multi-touch input. The operating system may also have default mappings of multi-touch inputs to functionality, and these default mappings can be overridden by the application. Accordingly, the operating system performs the default mapped-to functionality when a multi-touch input is detected unless overridden by the application, in which case the mapped-to functionality indicated by the application is performed.

Additionally or alternatively, the operating system notifies the application of a detected multi-touch input to the on-screen keyboard and the application determines what functionality (if any) to perform in response to the multi-touch input. The operating system can pass all detected multi-touch inputs to the application or only a subset of detected multi-touch inputs to the application. For example, the application can register with the operating system for which multi-touch inputs the application wants to be notified of, and the operating system notifies the application when those registered for multi-touch inputs are detected.

The techniques discussed herein allow an operating system to provide an on-screen keyboard that is usable by multiple different applications. Each application can effectively program or configure the on-screen keyboard as desired by the application, allowing each application to customize multi-touch inputs to whatever functionality the application desires. This alleviates the application and application developer from the need to provide its own on-screen keyboard, thereby reducing application complexity and development time.

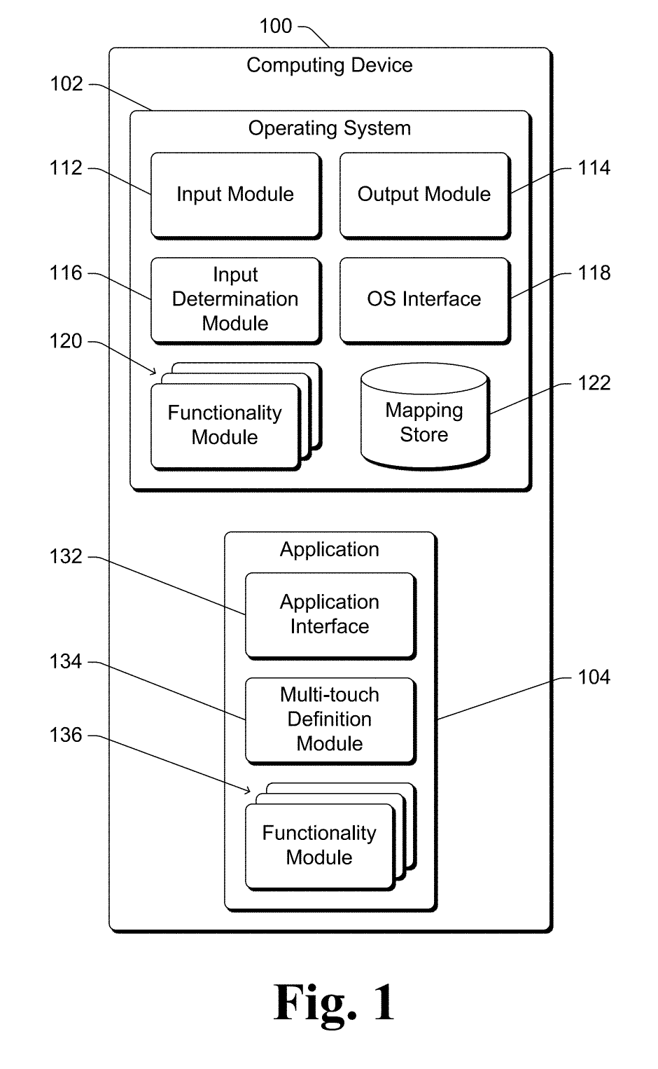

FIG. 1 is a block diagram illustrating an example computing device 100 implementing the programmable multi-touch on-screen keyboard in accordance with one or more embodiments. Computing device 100 can be a variety of different types of devices, such as a desktop computer, a server computer, a laptop or netbook computer, a mobile device (e.g., a tablet or phablet device, a cellular or other wireless phone (e.g., a smartphone), a notepad computer, a mobile station), a wearable device (e.g., eyeglasses, head-mounted display, watch, bracelet, augmented reality (AR) devices, virtual reality (VR) devices), an entertainment device (e.g., an entertainment appliance, a set-top box communicatively coupled to a display device, a game console), Internet of Things (IoT) devices (e.g., objects or things with software, firmware, and/or hardware to allow communication with other devices), a television or other display device, an automotive computer, and so forth. Thus, computing device 100 may range from a full resource device with substantial memory and processor resources (e.g., personal computers, game consoles) to a low resource device with limited memory and/or processing resources (e.g., traditional set-top boxes, hand-held game consoles).

Computing device 100 includes an operating system 102 and an application 104. The operating system 102 manages the running of application 104 on the computing device 100. The operating system 102 provides an interface for application 104 to access various functionality and hardware components of the computing device 100. The application 104 can be any of a variety of different types of applications, such as productivity applications, entertainment applications, Web applications, and so forth. Although a single application 104 is shown in FIG. 1, it should be noted that multiple applications 104 can be included in the computing device 100.

The operating system 102 includes an input module 112, an output module 114, an input determination module 116, an operating system (OS) interface 118, one or more functionality modules 120, and a mapping store 122. The output module 114 generates, manages, and/or outputs content for display, playback, and/or other presentation. This content can be created by the output module 114 and/or obtained from other modules of the computing device 100. This content can be, for example, a display or playback portion of a user interface (UI). This content includes an on-screen keyboard via which users can input commands or data to the computing device 100.

The output module 114 displays an on-screen keyboard on a touchscreen display of the computing device 100. In one or more embodiments, the touchscreen display is included as part of the computing device 100 (e.g., in the same housing as the processor, memory, and other hardware components of the computing device 100). Additionally or alternatively, the touchscreen display can be separate from but communicatively coupled to the computing device 100, such as coupled via a wired or wireless connection to the computing device 100.

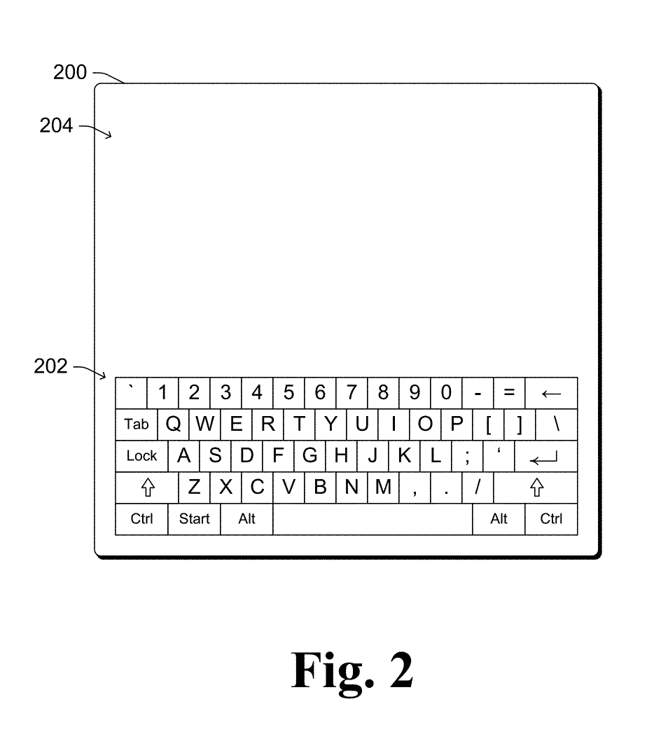

FIG. 2 illustrates an example on-screen keyboard in accordance with one or more embodiments. A touchscreen display 200 includes an on-screen keyboard 202 and a data display portion 204. The on-screen keyboard 202 is displayed as part of the touchscreen display and allows a user to input multi-touch inputs to the computing device 100 as discussed in more detail below. The data display portion 204 allows various data to be displayed as desired by the application 104, such as Web content, data being edited, video being played back, and so forth.

Returning to FIG. 1, the touchscreen display can sense inputs using a variety of different sensing technologies. These sensing technologies can include pressure sensitive systems that sense pressure or force. These input sensing technologies can also include capacitive systems and/or resistive systems that sense touch. These input sensing technologies can also include optical based images that sense reflection or disruption of light from objects touching (or close to) the surface of the display device, such as Sensor in Pixel (SIP) systems, Infrared systems, optical imaging systems, and so forth. Other types of input sensing technologies can also be used, such as surface acoustic wave systems, acoustic pulse recognition systems, dispersive signal systems, and so forth. Although examples of input sensing technologies are discussed herein, other input sensing technologies are also contemplated.

The input module 112 obtains touch information from the touchscreen display. Generally, the touch information refers to information describing an object that is part of or is controlled by the user (e.g., a finger, a stylus) physically touching or being within a threshold distance (e.g., 5 millimeters) of the on-screen keyboard. This threshold distance can vary based on the sensing technology used by the touchscreen display.

In one or more embodiments, this touch information is an indication of the amount of pressure applied by one or more objects over time, as well as the locations of the applied pressure over time, as sensed by the touchscreen display as discussed above. Additionally or alternatively, this touch information is an indication of the contact information applied by one or more objects over time, as well as the locations of the contact information over time, as sensed by the touchscreen display as discussed above. The contact information refers to the area that is touched (the portions of the touchscreen display that were touched by an object, the amount of light reflected by an object, etc.) by the user when touching the keyboard.

The input module 112 optionally senses other types of input from a user of the computing device 100. For example, user inputs can optionally be provided by pressing one or more keys of a keypad or keyboard of the computing device 100, pressing one or more keys of a controller (e.g., remote control device, mouse, track pad, etc.) of the computing device 100, an action that can be recognized by a motion detection or other component of the computing device 100 (such as shaking or rotating the computing device 100, audible inputs via a microphone, and so forth.

Multi-touch inputs include user inputs that are gestures on the on-screen keyboard. A gesture refers to a motion or path taken by one or more objects (e.g., the user's finger) across the on-screen keyboard. For example, a gesture may be sliding of the user's finger in a particular direction, the user's finger tracing a particular character or symbol (e.g., a circle, a letter “Z”, etc.), and so forth. A gesture can be the motion or path taken by a single object (e.g., a single finger tracing a character or symbol) across the on-screen keyboard. A gesture can also be the motions or paths taken by multiple objects concurrently (e.g., two of the user's fingers used to perform a two finger vertical upward swipe or a pinch in) take particular motions or paths across the on-screen keyboard.

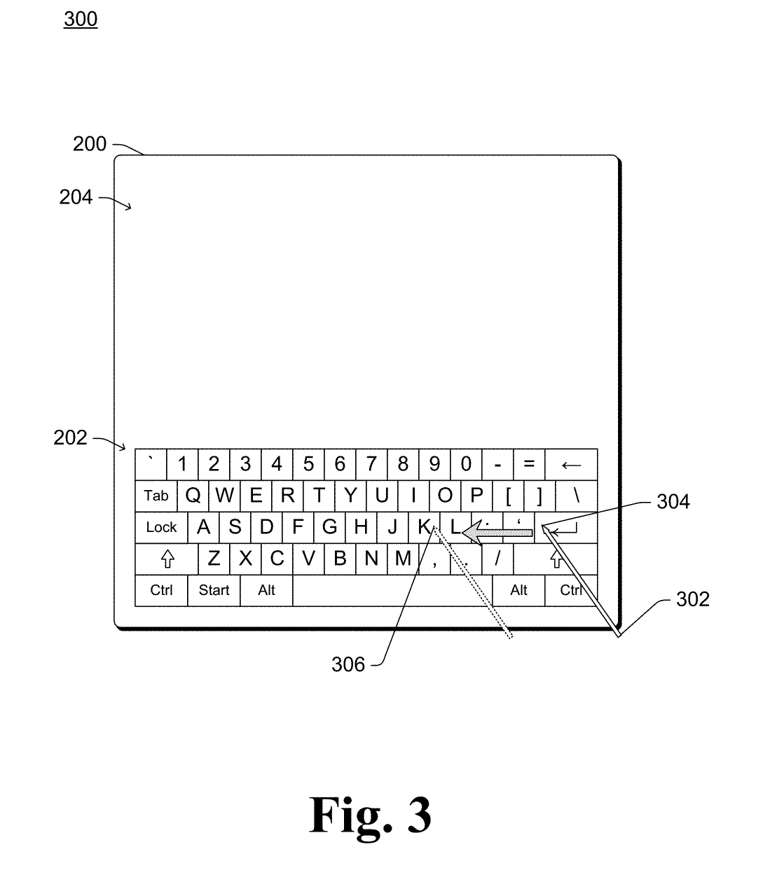

FIG. 3 illustrates an example of a multi-touch input in accordance with one or more embodiments. FIG. 3 illustrates the example touchscreen display 200 of FIG. 2 and a multi-touch input is received via the tip of a stylus 302. The multi-touch input in FIG. 3 is illustrated as a movement from right to left, with the multi-touch input beginning at 304 and ending at 306. The ending position of the stylus 302 is illustrated using a dashed outline of the stylus.

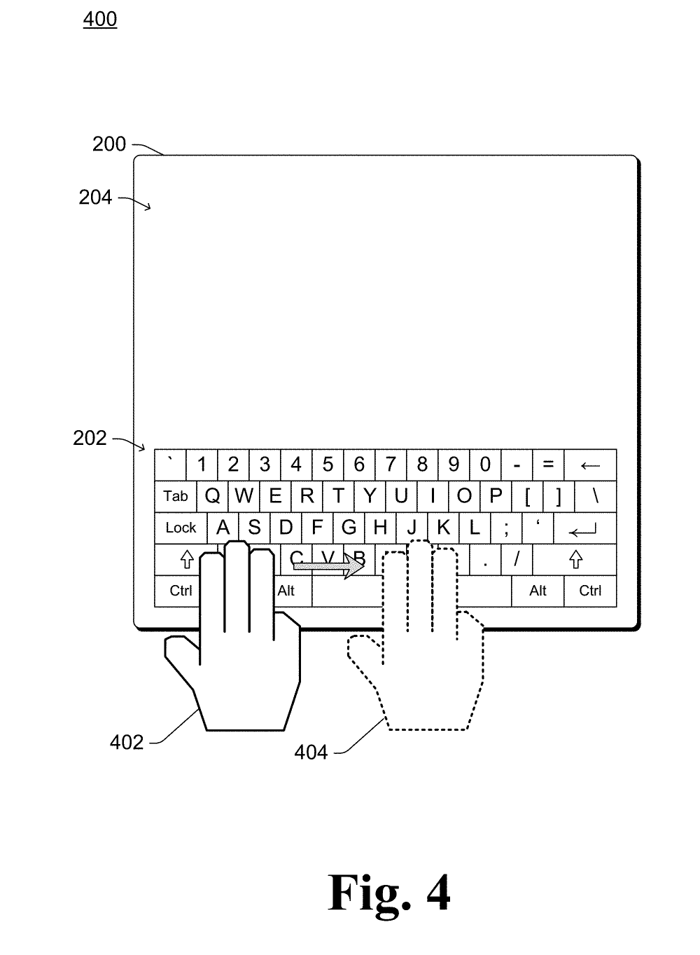

FIG. 4 illustrates another example of a multi-touch input in accordance with one or more embodiments. FIG. 4 illustrates the example touchscreen display 200 of FIG. 2 and a multi-touch input is received via a three-finger gesture. The multi-touch input in FIG. 4 is illustrated as a movement from left to right, with the multi-touch input beginning with the fingers of the hand at 402 and ending with the fingers of the hand at 404. The ending position of the hand 406 is illustrated using a dashed outline of the hand.

Returning to FIG. 1, multi-touch inputs also include user inputs that are multiple objects touching the on-screen keyboard concurrently but remaining approximately stationary (e.g., two or three fingers each touching a different key of the on-screen keyboard). An object remaining approximately stationary refers to an object that may move slightly (e.g., as a user's hand wobbles) but is not a longer motion or path taken across multiple keys of the on-screen keyboard. For example, an object can be considered to be remaining approximately stationary if the object moves across the on-screen keyboard at than a threshold rate (e.g., 2 millimeters per second).

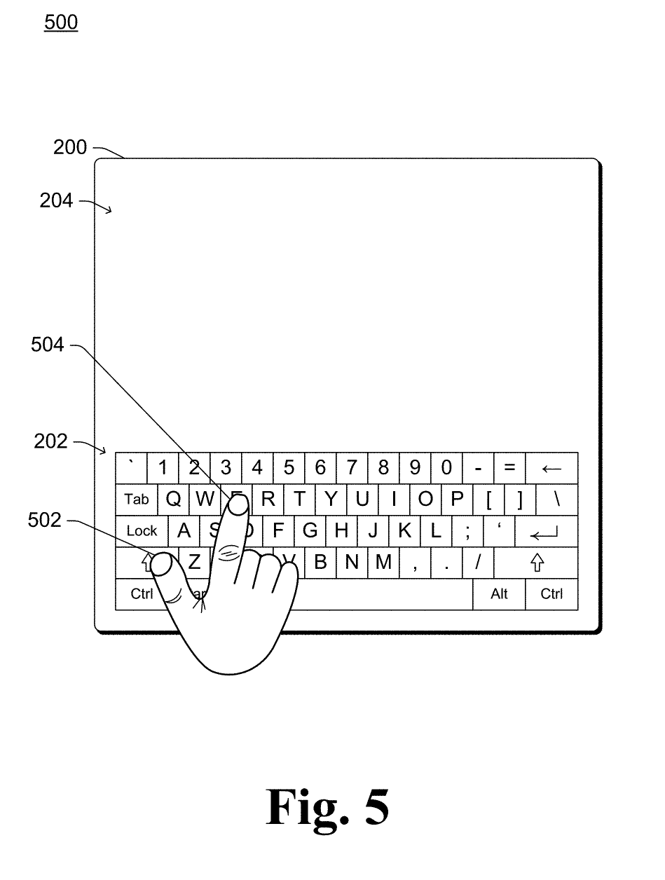

FIG. 5 illustrates another example of a multi-touch input in accordance with one or more embodiments. FIG. 5 illustrates the example touchscreen display 200 of FIG. 2 and a multi-touch input is received via fingers of a hand. The multi-touch input in FIG. 5 is illustrated as two fingers (the thumb 502 and index finger 504) concurrently touching the on-screen keyboard. As illustrated, the thumb 502 is touching the Shift key and the index finger 504 is touching the E key.

Multi-touch inputs also include user inputs that are a combination of a gesture and an object touching the on-screen keyboard but remaining approximately stationary. For example, a multi-touch input can be one finger remaining approximately stationary (e.g., on a particular key of the on-screen keyboard, such as the Shift key) concurrently with another finger tracing a particular character or symbol (e.g., a circle, a letter “Z”, etc.).

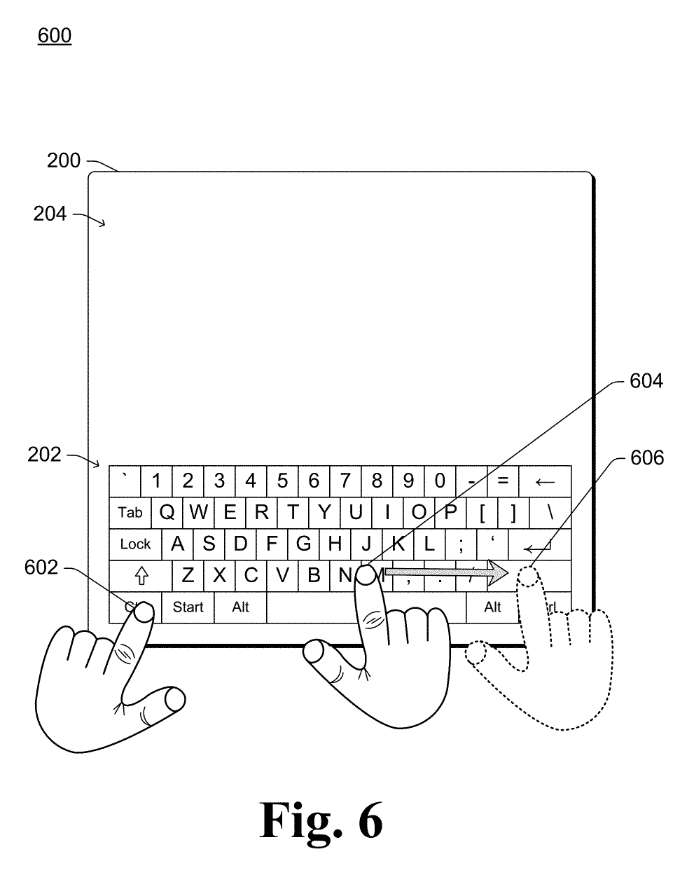

FIG. 6 illustrates another example of a multi-touch input in accordance with one or more embodiments. FIG. 6 illustrates the example touchscreen display 200 of FIG. 2 and a multi-touch input is received via multiple fingers. The multi-touch input in FIG. 6 is illustrated as one finger remaining approximately stationary at 602 (on the Ctrl key) concurrently with another finger moving from left to right input, beginning with the finger at 604 and ending with the finger at 606. The ending position of the finger at 606 is illustrated using a dashed outline of the hand.

Returning to FIG. 1, the input determination module 116 receives from the input module 112 an indication of the touch information sensed by the touchscreen display and classifies the touch information. The touch information can include various characteristics, such as the size of a touched area (e.g., the amount of area touched), changes in the size of the touched area over time, the shape of the touched area (e.g., a geographic shape or outline of the area touched), changes in the shape of the touched area over time, the location of the touched area over time, the change in pressure of the touched area over time, the movement of the object (directions and locations that are touched), a velocity of the object, an acceleration of the object, a distance the object travels across the touchscreen display, combinations thereof, and so forth.

The touch information is classified as or detected as being one of multiple different user inputs. Various different public and/or proprietary criteria can be used to determine the classification of the touch information, such as various rules, algorithms, and so forth. These different criteria can be included as part of the input determination module 116 (e.g., programmed into the input determination module 116). Additionally or alternatively, these different criteria can be obtained by the input determination module 116 from other devices or modules. These user inputs can include various different user inputs, such as selection of a particular key on the on-screen keyboard, inputting of a gesture on the on-screen keyboard, and so forth. These multiple different user inputs include one or more multi-touch inputs.

In one or more embodiments, one of the criteria used in classifying the touch information is whether the touch information describes touched locations of the on-screen keyboard. The input determination module 116 can classify the touch information as a particular multi-touch input in response to the touch information describing touched locations on the on-screen keyboard.

The mapping store 122 includes a mapping of user inputs to functionality. The mapping store 122 can be implemented in any of a variety of different types of memory devices or storage devices, such as random access memory, Flash memory, magnetic disk, and so forth. The input determination module 116 includes one or more records or other data structures that map a particular user input to a particular functionality. After classifying or detecting touch information as a particular user input, the input determination module 116 uses the mapping store 122 to identify what functionality is mapped to (corresponds to) that user input. Touch information can be classified as various different user inputs, including a single-touch input (e.g., a single object touching the on-screen keyboard and remaining approximately stationary) or a multi-touch input.

In one or more embodiments, the mapping store 122 maintains a record of mappings of user inputs to functionality for application 104 (and optionally additional applications) in nonvolatile memory. This record of mappings can thus be maintained across restarts or resets of the computing device 100, and each time the application 104 is run the mappings for the different user inputs are available to the input determination module 116. Additionally or alternatively, the application 104 can provide mappings to the input determination module 116 when the application 104 is running (e.g., at the beginning of executing the application 104). In such situations, the record of mappings need not be maintained across restarts or resets of the computing device 100.

A user input can be mapped to any of a variety of different functionalities, such as key selection, text editing operations, font size or type changes, text selection, navigation of a cursor (e.g., displayed in the data display area 204 of FIG. 2), and so forth. For example, the different functionalities can include selection of a word displayed in the data display area 204, selection of a line of text displayed in the data display area 204, bold-facing or underlining of selected text in the data display area 204, decreasing the font size of text that is being typed using the on-screen keyboard (e.g., and displayed in the data display area 204), increasing or decreasing the font size of text that is being typed using the on-screen keyboard (e.g., and displayed in the data display area 204), scrolling content displayed in the data display area 204 upwards or downwards, moving the cursor displayed in the data display area 204 vertically upward or downward, and so forth.

The input determination module 116 invokes an appropriate functionality module 120 to perform the mapped-to functionality for the user input. The appropriate functionality module 120 to invoke can be pre-configured in the input determination module 116. Additionally or alternatively, the appropriate functionality module 120 can be determined in different manners, such as obtained from the mapping store 122 (e.g., as metadata associated with the user input to functionality mapping), obtained from another device or module, and so forth.

In one or more embodiments, each functionality module 120, when invoked, performs a single functionality (e.g., scrolls content displayed in the data display area 204 upwards or downwards). Additionally or alternatively, a functionality module 120 can perform multiple different functionalities and the input determination module 116, when invoking the functionality module 120, provides to the functionality module 120 an indication of the particular functionality to be performed (e.g., provides the indication as a parameter when invoking the functionality module 120).

The operating system 102 exposes the OS interface 118 to the application 104 running on the computing device 100. The OS interface 118 can be, for example, an application programming interface (API). The application 104 includes an application interface 132, a multi-touch definition module 134, and one or more functionality modules 136.

The application 104 can specify (e.g., by the multi-touch definition module 134 invoking a method of the OS interface 118) what functionality particular multi-touch inputs map to. The application 104 can specify functionality for a single multi-touch input or multiple different multi-touch inputs. The multi-touch definition module 134 can specify a particular multi-touch input in different manners. In one or more embodiments, the multi-touch definition module 134 knows which multi-touch inputs are supported by (e.g., known to) the input determination module 116. This knowledge can be obtained in various manners, such as by invoking a method of the OS interface 118 to enumerate the different multi-touch inputs that functionalities are mapped to in the mapping store 122. In such situations, the multi-touch definition module 134 can specify a particular multi-touch input by a name or other identifier known to the input determination module 116.

Additionally or alternatively, the multi-touch definition module 134 can define its own multi-touch inputs. Defining a multi-touch input refers to providing to the input determination module 116 the criteria used to describe the multi-touch input (the criteria used by the input determination module 116 to classify touch information as the multi-touch input). The input determination module 116 can then add to the mapping store 122 the criteria used to describe the multi-touch input and the functionality to which the multi-touch input is mapped. The multi-touch input can be specified by a name or identifier (e.g., provided by the multi-touch definition module 134), and/or in other matters such as by the provided criteria used to describe the multi-touch input. Similarly, the application 104 can define its own single-touch inputs if desired.

The input determination module 116 receives the specified mapping from the multi-touch definition module 134 and updates the mapping store 122 to include a record of the specified multi-touch input as being mapped to the specified functionality. In one or more embodiments, the mapping store 122 includes default mappings of multi-touch input inputs to functionality, and these default mappings can be overridden by the application 104. If the input determination module 116 receives a mapping of a multi-touch input to particular functionality and the mapping store 122 already has the multi-touch input mapped to different functionality, then the input determination module 116 replaces (e.g., overwrites) the previously stored functionality with the newly received functionality. Accordingly, the input determination module 116 performs the default mapped-to functionality when a multi-touch input is detected unless overridden by the application 104, in which case the mapped-to functionality indicated by the application is performed.

In one or more embodiments, performing the mapped-to functionality includes calling on the application 104 to perform at least part of the functionality. The application 104 includes an application interface 132, which can take various forms such as an API, a callback function to assist in performing mapped-to functionality, and so forth. For example, if the mapped-to functionality indicates that a currently selected word is to have its font type changed, the functionality module 120 of the operating system 102 can send a request to the application 104, by invoking the application interface 132, of the font type change. An appropriate functionality module 136 in the application 104 can then perform the specified font change for the selected word.

The functionality modules 136 can be invoked similar to the functionality modules 120, although the functionality modules 136 can be invoked by the application interface 132 in response to a request from a functionality module 120. In one or more embodiments, each functionality module 136, when invoked, performs a single functionality (e.g., changes the font type of selected text). Additionally or alternatively, a functionality module 136 can perform multiple different functionalities and the application interface 132, when invoking the functionality module 136, provides to the functionality module 136 an indication of the particular functionality to be performed (e.g., provides the indication as a parameter when invoking the functionality module 136).

An application 104 is thus able to program or configure functionality for an on-screen keyboard as desired by the application 104. The application 104 can change what functionality is performed in response to particular multi-touch inputs, and can define its own multi-touch inputs.

It should be noted that multiple different applications can provide their own mappings, and different applications can provide different mappings. For example, one application can replace the default functionality for a multi-touch input whereas another application does not replace the default functionality for that multi-touch input. By way of another example, the one application can define its own multi-touch input that results in particular functionality when that one application is running but results in no functionality when other applications are running (or for other applications that are not the currently active application). The input determination module 116 maintains these different mappings in the mapping store 122 for the different applications so that the mapping for one application does not replace or affect the mapping for another application.

Additionally or alternatively, in some situations the input determination module 116 notifies the application 104 that a particular multi-touch input has been received. The input determination module 116 notifies the application 104 that the particular multi-touch input has been received by invoking the application interface 132. In response to the notification, the application interface 132 determines what functionality is to be performed and invokes the appropriate functionality module 136 to perform the functionality. The application interface 132 can determine what functionality is to be performed in various manners, such as by being pre-configured with a mapping of multi-touch inputs to functionalities, maintaining a mapping store (analogous to the mapping store 122 but only for the application 104), and so forth.

Thus, rather than relying on the operating system 102 to know the mappings of particular multi-touch inputs to functionalities, the application 104 can have such knowledge. The input determination module 116 only identifies the multi-touch inputs, and relies on the application 104 to perform the appropriate functionality.

In one or more embodiments, the input determination module 116 notifies the application 104 that a particular multi-touch input has been received for all multi-touch inputs. Thus, the input determination module 116 need not maintain multi-touch input to functionality mappings for any multi-touch inputs for the application 104.

Additionally or alternatively, the input determination module 116 notifies the application 104 that a particular multi-touch input has been received for only a subset of multi-touch inputs. This subset can be determined in different manners. For example, the application 104 can register with the input determination module 116 for which multi-touch inputs the application 104 is to be notified of In response to detecting a multi-touch input that is included in the subset of multi-touch inputs, the input determination module 116 notifies the application 104 that the multi-touch input has been received. However, in response to detecting a multi-touch input that is not included in the subset of multi-touch inputs, the input determination module 116 uses the mappings in the mapping store 122 to determine the mapped-to functionality for the multi-touch input, and invokes the appropriate functionality module 120 to perform the mapped-to functionality.

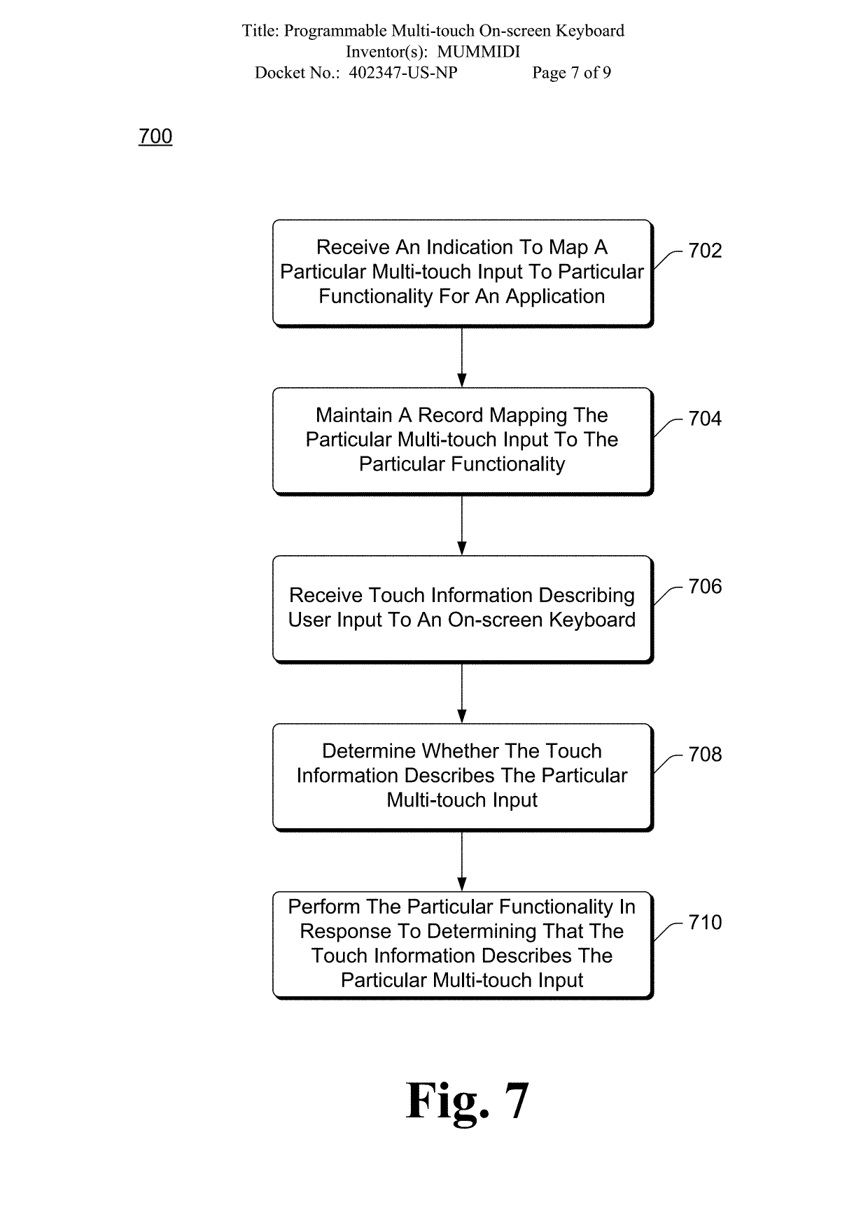

FIG. 7 is a flowchart illustrating an example process 700 for implementing a programmable multi-touch on-screen keyboard in accordance with one or more embodiments. Process 700 is carried out by a device, such as an operating system 102 of the computing device 100 of FIG. 1, and can be implemented in software, firmware, hardware, or combinations thereof. Process 700 is shown as a set of acts and is not limited to the order shown for performing the operations of the various acts. Process 700 is an example process for implementing a programmable multi-touch on-screen keyboard; additional discussions of implementing a programmable multi-touch on-screen keyboard are included herein with reference to different figures.

In process 700, an indication to map a particular multi-touch input to particular functionality for an application is received (act 702). The indication is received from the application as discussed above.

A record mapping the particular multi-touch input to the particular functionality is maintained (act 704). This record can be a replacement to a previous mapping (e.g., a default mapping or a mapping previously provided by the application) or a new mapping (e.g., for a multi-touch input defined by the application).

Touch information describing user input to an on-screen keyboard is received (act 706). This touch information can be, for example, an amount of pressure applied by one or more objects over time, contact information over time, and so forth. The user input to the on-screen keyboard refers to a user input over or on top of the on-screen keyboard, for example as shown in FIGS. 3-6.

A determination is made as to whether the touch information describes the particular multi-touch input (act 708). This determination is made by applying various different rules, algorithms, and so forth to the touch information as discussed above.

In response to determining that the touch information describes the particular multi-touch input, the particular functionality is performed (act 710). The particular functionality is performed by invoking an appropriate functionality module as discussed above, and may involve communicating requests to the application.

If the touch information does not describe the particular multi-touch input, then the particular functionality is not performed in response to the touch information. Rather, other functionality (or no functionality) may be performed.

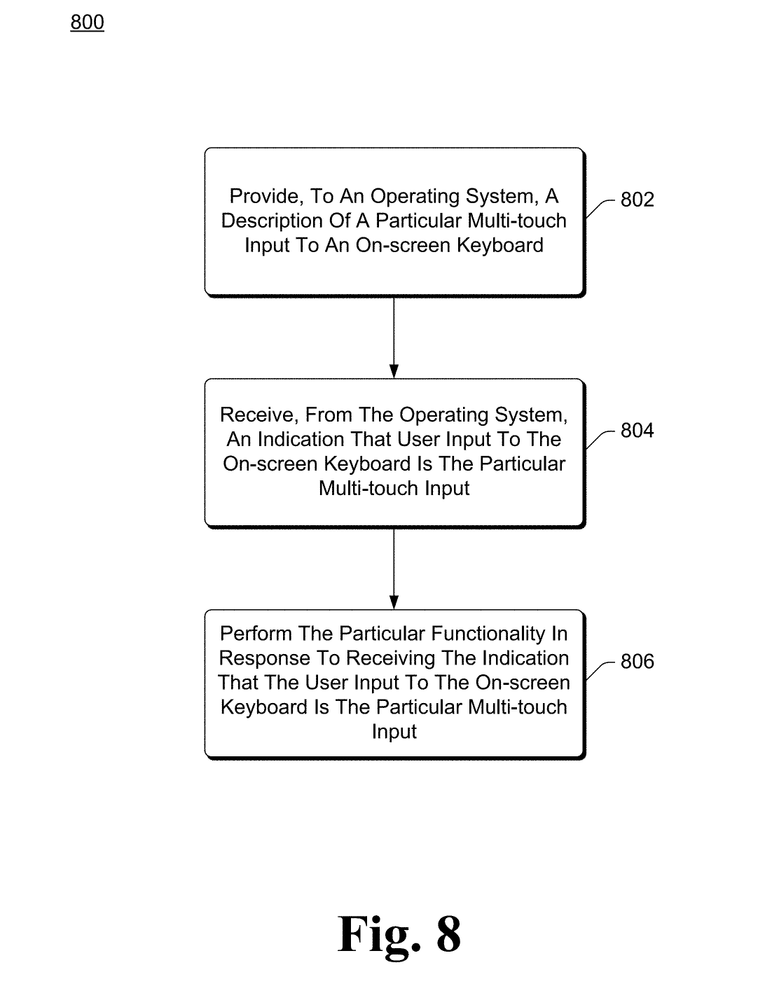

FIG. 8 is a flowchart illustrating an example process 800 for implementing a programmable multi-touch on-screen keyboard in accordance with one or more embodiments. Process 800 is carried out by a device, such as an application 104 of the computing device 100 of FIG. 1, and can be implemented in software, firmware, hardware, or combinations thereof. Process 800 is shown as a set of acts and is not limited to the order shown for performing the operations of the various acts. Process 800 is an example process for implementing a programmable multi-touch on-screen keyboard; additional discussions of implementing a programmable multi-touch on-screen keyboard are included herein with reference to different figures.

In process 800, an application provides a description of a particular multi-touch input to an on-screen keyboard (act 802). This description of the multi-touch input can be a multi-touch input defined by the application, or can be an identifier of a previously known or defined multi-touch input.

Subsequently, an indication is received from the operating system that user input to the on-screen keyboard is the particular multi-touch input (act 804). The user input to the on-screen keyboard is touch information that is classified as the particular multi-touch input as discussed above.

In response to the indication in act 804, the particular functionality is performed (806). The particular functionality can be performed by invoking an appropriate functionality module of the application as discussed above.

In contrast to on-screen keyboards that allow only a single keystroke or touch at a time, the techniques discussed herein support various multi-touch inputs to an on-screen keyboard. This allows, for example, a user to enter a Shift-G-R sequence by concurrently touching locations of the on-screen keyboard corresponding to the Shift key, the G key, and the R key. By way of another example, this allows the user to input various different gestures (single finger or multiple finger) to the on-screen keyboard.

Gestures can be mapped to various different functionality. For example, a Pinch In gesture (two objects concurrently touching the on-screen keyboard and moving towards each other) can decrease the font size of text that is being typed using the on-screen keyboard. By way of another example, a Pinch Out gesture (two objects concurrently touching the on-screen keyboard and moving away from each other) can increase the font size of text that is being typed using the on-screen keyboard. By way of another example, a Circular (clockwise) gesture or two-finger vertical upward swipe gesture can scroll content being displayed elsewhere (other than where the on-screen keyboard is being displayed) on the touchscreen display upwards or move the cursor in a vertically upward direction. By way of yet another example, a Circular (counter-clockwise) gesture or two-finger vertical downward swipe gesture can scroll content being displayed elsewhere (other than where the on-screen keyboard is being displayed) on the touchscreen display downwards or move the cursor in a vertically downward direction. By way of yet another example, a two-finger tap input (e.g., with each finger remaining approximately stationary on the touchscreen display) can be used to select the whole word where the cursor is present, or bold/underline the text if the text is already selected.

Although particular functionality is discussed herein with reference to particular modules, it should be noted that the functionality of individual modules discussed herein can be separated into multiple modules, and/or at least some functionality of multiple modules can be combined into a single module. Additionally, a particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

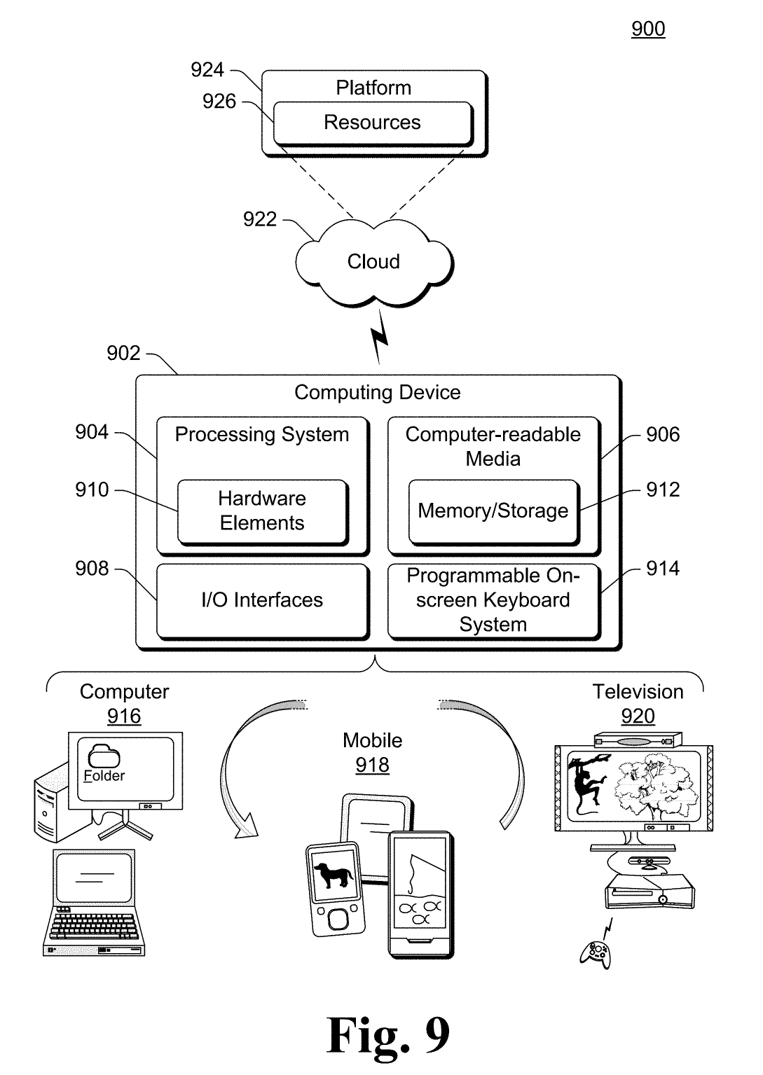

FIG. 9 illustrates an example system generally at 900 that includes an example computing device 902 that is representative of one or more systems and/or devices that may implement the various techniques described herein. The computing device 902 may be, for example, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O Interfaces 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware elements 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 906 is illustrated as including memory/storage 912. The memory/storage 912 represents memory/storage capacity associated with one or more computer-readable media. The memory/storage 912 may include volatile media (such as random access memory (RAM)) and/or nonvolatile media (such as read only memory (ROM), Resistive RAM (ReRAM), Flash memory, optical disks, magnetic disks, and so forth). The memory/storage 912 may include fixed media (e.g., RAM, ROM, a fixed hard drive, and so on) as well as removable media (e.g., Flash memory, a removable hard drive, an optical disc, and so forth). The memory/storage 912 may include storage-class memory (SCM) such as 3D Xpoint memory available from Intel Corporation of Santa Clara, Calif. or Micron Technology, Inc. of Boise, Id. The computer-readable media 906 may be configured in a variety of other ways as further described below.

The one or more input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 902 may be configured in a variety of ways as further described below to support user interaction.

The computing device 902 also includes a programmable on-screen keyboard system 914. The programmable on-screen keyboard system 914 provides various functionality for a programmable multi-touch on-screen keyboard as discussed above. The programmable on-screen keyboard system 914 can implement, for example, the input determination module 116 of FIG. 1, or the multi-touch definition module 134 of FIG. 1.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” refers to media and/or devices that are tangible, that enable persistent storage of information and/or storage, in contrast to mere signal transmission, carrier waves, or signals per se. Computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, the hardware elements 910 and computer-readable media 906 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of modules as a module that is executable by the computing device 902 as software may be achieved at least partially in hardware, e.g., through use of computer-readable storage media and/or hardware elements 910 of the processing system. The instructions and/or functions may be executable/operable by one or more articles of manufacture (for example, one or more computing devices 902 and/or processing systems 904) to implement techniques, modules, and examples described herein.

As further illustrated in FIG. 9, the example system 900 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 900, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 902 may assume a variety of different configurations, such as for computer 916, mobile 918, and television 920 uses. Each of these configurations includes devices that may have generally different constructs and capabilities, and thus the computing device 902 may be configured according to one or more of the different device classes. For instance, the computing device 902 may be implemented as the computer 916 class of a device that includes a personal computer, desktop computer, a multi-screen computer, laptop computer, netbook, and so on.

The computing device 902 may also be implemented as the mobile 918 class of device that includes mobile devices, such as a mobile phone, portable music player, portable gaming device, a tablet computer, a multi-screen computer, and so on. The computing device 902 may also be implemented as the television 920 class of device that includes devices having or connected to generally larger screens in casual viewing environments. These devices include televisions, set-top boxes, gaming consoles, and so on.

The techniques described herein may be supported by these various configurations of the computing device 902 and are not limited to the specific examples of the techniques described herein. This functionality may also be implemented all or in part through use of a distributed system, such as over a “cloud” 922 via a platform 924 as described below.

The cloud 922 includes and/or is representative of a platform 924 for resources 926. The platform 924 abstracts underlying functionality of hardware (e.g., servers) and software resources of the cloud 922. The resources 926 may include applications and/or data that can be utilized while computer processing is executed on servers that are remote from the computing device 902. Resources 926 can also include services provided over the Internet and/or through a subscriber network, such as a cellular or Wi-Fi network.

The platform 924 may abstract resources and functions to connect the computing device 902 with other computing devices. The platform 924 may also serve to abstract scaling of resources to provide a corresponding level of scale to encountered demand for the resources 926 that are implemented via the platform 924. Accordingly, in an interconnected device embodiment, implementation of functionality described herein may be distributed throughout the system 900. For example, the functionality may be implemented in part on the computing device 902 as well as via the platform 924 that abstracts the functionality of the cloud 922.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A method implemented in a computing device, the method comprising: receiving, from an application running on the computing device, an indication to map a first multi-touch input to first functionality; maintaining a record of a mapping of the first multi-touch input to the first functionality; receiving touch information describing user input to an on-screen keyboard of the computing device; determining whether the touch information describes the first multi-touch input; and performing the first functionality in response to determining that the touch information describes the first multi-touch input.

Alternatively or in addition to any of the methods or devices described herein, any one or combination of: the mapping overriding a default mapping for the first multi-touch input; the method implemented by an operating system of the computing device; the receiving the indication from the application comprising receiving the indication via an application programming interface exposed by the operating system; further comprising maintaining records of multiple multi-touch inputs each mapped to a different functionality; maintaining the record across restarts of the computing device; further comprising receiving, from the application, a description of a second multi-touch input, maintaining a record of the second multi-touch input, determining whether the touch information is the second multi-touch input, and notifying the application, in response to determining that the touch information is the second multi-touch input, that the second multi-touch input has been received; the first multi-touch input comprising a gesture; the first multi-touch input comprising two objects concurrently touching the keyboard; the first multi-touch input comprising one object touching the keyboard and remaining approximately stationary concurrently with a gesture on the keyboard from another object touching the keyboard.

A computing device method comprising: a processor; and a computer-readable storage medium having stored thereon multiple instructions that, responsive to execution by the processor, cause the processor to: provide, to an operating system on the computing device, a description of a first multi-touch input to an on-screen keyboard of the operating system; subsequently receive, from the operating system, an indication that a user input to the on-screen keyboard is the first multi-touch input; and perform first functionality in response to receiving the indication that the user input to the on-screen keyboard is the first multi-touch input.

Alternatively or in addition to any of the methods or devices described herein, any one or combination of: the multiple instructions further causing the processor to provide, to the operating system, an indication to map a second multi-touch input to second functionality, the operating system maintaining a record of a mapping of the second multi-touch input to the second functionality and performing the second functionality in response to touch information describing user input that is the second multi-touch input.

A computing device method comprising: a processor; a mapping store maintaining records of multi-touch input to functionality mappings; and a computer-readable storage medium having stored thereon multiple instructions that, responsive to execution by the processor, cause the processor to: receive, from an application running on the computing device, an indication to map a first multi-touch input to first functionality; maintain a record of a mapping of the first multi-touch input to the first functionality in the mapping store; receive touch information describing user input to an on-screen keyboard of the computing device; determine whether the touch information describes the first multi-touch input; and perform the first functionality in response to determining that the touch information describes the first multi-touch input.

Alternatively or in addition to any of the methods or devices described herein, any one or combination of: the mapping of the first multi-touch input to the first functionality overriding a default mapping for the first multi-touch input in the mapping store; the multiple instructions implementing an operating system of the computing device; wherein to maintain the record of the mapping of the first multi-touch input to the first functionality is to maintain the mapping of the first multi-touch input to the first functionality across restarts of the computing device; the multiple instructions further causing the processor to receive, from the application, a description of a second multi-touch input, maintain a record of the second multi-touch input, determine whether the touch information is the second multi-touch input, and notify the application, in response to determining that the touch information is the second multi-touch input, that the second multi-touch input has been received; the first multi-touch input comprising a gesture; the first multi-touch input comprising two objects concurrently touching the keyboard while remaining approximately stationary; the first multi-touch input comprising one object touching the keyboard and remaining approximately stationary concurrently with a gesture on the keyboard from another object touching the keyboard.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented in a computing device, the method comprising:
receiving, from an application running on the computing device, an indication to map a first multi-touch input to first functionality;
maintaining a record of a mapping of the first multi-touch input to the first functionality;
receiving touch information describing user input to an on-screen keyboard of the computing device;
determining whether the touch information describes the first multi-touch input; and
performing the first functionality in response to determining that the touch information describes the first multi-touch input.

2. The method as recited in claim 1, the mapping overriding a default mapping for the first multi-touch input.

3. The method as recited in claim 1, the method implemented by an operating system of the computing device.

4. The method as recited in claim 3, the receiving the indication from the application comprising receiving the indication via an application programming interface exposed by the operating system.

5. The method as recited in claim 1, further comprising maintaining records of multiple multi-touch inputs each mapped to a different functionality.

6. The method as recited in claim 1, maintaining the record across restarts of the computing device.

7. The method as recited in claim 1, further comprising:
receiving, from the application, a description of a second multi-touch input;
maintaining a record of the second multi-touch input;
determining whether the touch information is the second multi-touch input; and
notifying the application, in response to determining that the touch information is the second multi-touch input, that the second multi-touch input has been received.

8. The method as recited in claim 1, the first multi-touch input comprising a gesture.

9. The method as recited in claim 1, the first multi-touch input comprising two objects concurrently touching the keyboard.

10. The method as recited in claim 1, the first multi-touch input comprising one object touching the keyboard and remaining approximately stationary concurrently with a gesture on the keyboard from another object touching the keyboard.

11. A computing device method comprising:
a processor; and
a computer-readable storage medium having stored thereon multiple instructions that, responsive to execution by the processor, cause the processor to:
provide, to an operating system on the computing device, a description of a first multi-touch input to an on-screen keyboard of the operating system;
subsequently receive, from the operating system, an indication that a user input to the on-screen keyboard is the first multi-touch input; and
perform first functionality in response to receiving the indication that the user input to the on-screen keyboard is the first multi-touch input.

12. The computing device as recited in claim 11, the multiple instructions further causing the processor to provide, to the operating system, an indication to map a second multi-touch input to second functionality, the operating system maintaining a record of a mapping of the second multi-touch input to the second functionality and performing the second functionality in response to touch information describing user input that is the second multi-touch input.

13. A computing device method comprising:
a processor;
a mapping store maintaining records of multi-touch input to functionality mappings; and
a computer-readable storage medium having stored thereon multiple instructions that, responsive to execution by the processor, cause the processor to:
receive, from an application running on the computing device, an indication to map a first multi-touch input to first functionality;
maintain a record of a mapping of the first multi-touch input to the first functionality in the mapping store;
receive touch information describing user input to an on-screen keyboard of the computing device;
determine whether the touch information describes the first multi-touch input; and
perform the first functionality in response to determining that the touch information describes the first multi-touch input.

14. The computing device as recited in claim 13, the mapping of the first multi-touch input to the first functionality overriding a default mapping for the first multi-touch input in the mapping store.

15. The computing device as recited in claim 13, the multiple instructions implementing an operating system of the computing device.

16. The computing device as recited in claim 13, wherein to maintain the record of the mapping of the first multi-touch input to the first functionality is to maintain the mapping of the first multi-touch input to the first functionality across restarts of the computing device.

17. The computing device as recited in claim 13, the multiple instructions further causing the processor to:
receive, from the application, a description of a second multi-touch input;
maintain a record of the second multi-touch input;
determine whether the touch information is the second multi-touch input; and
notify the application, in response to determining that the touch information is the second multi-touch input, that the second multi-touch input has been received.

18. The computing device as recited in claim 13, the first multi-touch input comprising a gesture.

19. The computing device as recited in claim 13, the first multi-touch input comprising two objects concurrently touching the keyboard while remaining approximately stationary.

20. The computing device as recited in claim 13, the first multi-touch input comprising one object touching the keyboard and remaining approximately stationary concurrently with a gesture on the keyboard from another object touching the keyboard.
